(19) United States
(12) Patent Application Publication
(10) Pub. No.: US 2023/0163282 A1
(43) Pub. Date: May 25, 2023

(54) SILICON-BASED ANODES FOR HIGH ENERGY-DENSITY, HIGH CYCLE-LIFE LITHIUM-ION BATTERY

(71) Applicants: Zhigang Lin, Irvine, CA (US); Shuyi Chen, Irvine, CA (US); Chunhu Tan, Irvine, CA (US)

(72) Inventors: Zhigang Lin, Irvine, CA (US); Shuyi Chen, Irvine, CA (US); Chunhu Tan, Irvine, CA (US)

(21) Appl. No.: 17/455,810

(22) Filed: Nov. 19, 2021

(51) Int. Cl. H01M 4/38; H01M 4/62; H01M 4/505; H01M 4/525; H01M 4/04

(52) U.S. Cl. CPC H01M 4/386; H01M 4/625; H01M 4/505; H01M 4/525; H01M 4/0471; H01M 4/043; H01M 4/0416

(57) ABSTRACT

A high-energy-density, high-cycling-life Si-based anode is used for rechargeable Lithium-ion batteries with either solid-state electrolyte or currently commercialized liquid electrolyte. The Si-based anodes include a silicon-based active material, conductive agent(s), and polymer(s) that act as binder(s). The silicon-based active material includes silicon, graphite, metallic or non-metallic oxide, and/or a polymer. The electrode has a specific capacity of at least 2328 mAh/g when cycled at a charge-discharge rate of about 0.5 C and 3245 mAh/g at 0.05 C. Sheets of the Si-based electrode are processable with a well-established industrial process that is cost-effective, scalable, and compatible with currently used Li-ion production lines. A lithium electrochemical pouch cell is manufactured with the Si-based anode sheet with either a liquid electrolyte or a solid-state electrolyte to offer high energy density, long cycle life, and high charge/discharge rates.

### BACKGROUND OF THE INVENTION

The present invention relates to Lithium-ion batteries and, more particularly, to Si-based anodes which have high specific capacities and extraordinary cycling stability and lifetime.

Lithium-ion batteries have been used to power a wide range of products from portable devices to electric vehicles. The increasing throughput in electric-powered devices and vehicles requires the batteries to supply more energy with the same volume or even smaller volume.

Lithium electrochemical cells typically include an anode, a lithium electrolyte prepared from a lithium salt dissolved in organic solvents, and a cathode of an electrochemically active material. Typically, low molecular organic solvents are added to dissolve lithium salt which are used to provide mobile lithium ions during the electrochemical charging and discharging processes. In the course of discharging, lithium ions are released from the anode to the cathode through the electrolyte and, in some cases, a separator. Electrical energy is simultaneously released as lithium ions are taken up by the cathode. In the course of charging, the flow of lithium ions is reversed. Lithium ions are transported from the electrochemical cathode through the electrolyte and plated back onto the anode.

Lithium-ion batteries with Si and Si-based anodes can overcome energy limitations. Si has a theoretical capacity of 4200 mAh/g while conventional graphite anode material only has a theoretical capacity of 372 mAh/g. With more than 11 times higher specific capacity, the energy density of an electrochemical cell with a Si anode can also be greatly improved. The resultant cell is thus much lighter and smaller. However, there is one challenge in using Si as anode, which is its huge volume change (300%) during the lithiation and delithiation process of electrochemical cell. The repeated volume change causes Si particle isolation, active material and conductive material looseness, active material crack, and anode sheet crack. The volume expansion of Si particles during the lithiation and delithiation process leads to mechanical degradation and electric contact loss, resulting in continuous capacity loss and poor cycling performance. The volume change of Si is a severe drawback which hinders its practical application and brings unstable solid electrolyte interphase (SEI) stability issues to the electrochemical cell. SEI forms on the surface of Si particles during the delithiation (charging) process when the volume of Si particles is expanded. In the lithiation (discharging) process, Si particles shrink and the formed SEI layer breaks down into separate pieces, exposing fresh Si surface area in the electrolyte. In the later delithiation and lithiation cycles, new SEI layers continuously form on the Si particle surface and break down. The SEI layer accumulates thicker and thicker, which results in high overpotential for lithiation, accelerates the electrolyte consumption, prevents intimate contact between active materials, and leads to capacity loss and poor cycling life.

Another problem with using Si-based materials to fabricate anodes for electrochemical cells is the manufacturing processes. Current methods to prepare a Si anode include spray deposition, pulsed-laser deposition (PLD), and physical vapor deposition (PVD). These methods require sophisticated techniques and machines, which are not cost-effective and not compatible with current industrial

Lithium-ion battery production. These approaches cannot be directly applied on the conventional production line of Li-ion batteries. Machine and manufacturing line upgrades are needed to implement these methods, along with strict atmospheric requirements, which inhibits the large-scale production of high-capacity Si anodes for use in lithium-ion batteries.

As can be seen, there is a need for a Si-based anode that overcomes excessive volume change and SEI layer formation and is cost-effective to manufacture.

### SUMMARY OF THE INVENTION

The present invention relates to the development of silicon-based anodes which have high specific capacities (e.g., at least about 2328 mAh/g at 0.5 C rate), and excellent cycling stability and lifetime. The Si-based anode may be processed with industrial production lines well-established and known in the art. The resultant anode sheet may be directly incorporated into the manufacture of lithium-ion batteries to offer high energy density, long cycle life and high charge/discharge rate. These Si-based anodes may be used with a currently commercialized liquid electrolyte well known in the art or with a state-of-art solid-state electrolyte (SSE).

In one aspect of the present invention, a Si-based composite anode is provided that includes: a silicon-based anode active material, conductive agents, and a binder. The silicon-based anode active material may include (i) Si, (ii) graphite, (iii) a metallic or nonmetallic oxide, and (iv) polymer.

In another aspect of the present invention, an electrochemical cell is provided which includes: a Si-based anode that includes: a Si-based anode active material, a first conducting agent, and a first binder; a cathode that includes: a cathode active material, a second conducting agent, and a second binder; and a separator interposed between the Si-based anode and the cathode.

In this electrochemical cell, the Si-based anode thickness reduces to a size that is about 10-25% of commercially available graphite anode thickness. The total thickness of the cell may be reduced by about 35-40% and the total weight may be reduced by about 25-30%.

These and other features, aspects and advantages of the present invention will become better understood with reference to the following drawings, description, and claims.

### BRIEF DESCRIPTION OF THE DRAWINGS

FIG. 1A is a flow chart of a method of fabricating Si-based composite anode materials according to an embodiment of the present invention;

FIG. 1B is a scanning electron microscope (SEM) image of pristine Si anode active material for use with the inventive method;

FIG. 1C is a SEM image thereof, shown without a polyvinyl alcohol (PVA) coating;

FIG. 1D is a SEM image thereof, shown with a PVA coating;

FIG. 2 is a flow chart of a method of preparing carbon mix for the Si-based anode according to an embodiment of the present invention;

FIG. 3A is a flowchart of a method of preparing Si-based anode sheets according to an embodiment of the present invention;

FIG. 3B is a SEM of the Si anode sheet derived thereby;

FIG. 4 is a graph of charge-discharge profiles for a half coin cell with liquid electrolyte and non-thermal linked Si-based anodes;

FIG. 5 is a graph of cycling profiles therefor;

FIG. 6 is another graph thereof;

FIG. 7 is a graph of the charge-discharge profiles for a half coin cell with liquid electrolyte and thermal linked Si-based anodes;

FIG. 8 is a graph of cycling profiles therefor; and

FIG. 9 is another graph thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a Si-based anode material, and a Si-based anode sheet formed therefrom, that is particularly suited for used in lithium-ion electrochemical cells and batteries. The Si-based anode material is a composite comprising (1) Silicon, (2) graphite, (3) a metallic or non-metallic oxide, which prevents the volume change of Si particles in the lithiation and delithiation process, and, in some embodiments, (4) optional polymers. The Si-based anode comprises (1) the inventive Si-based anode material (also referred to herein as Si-based composite anode active material and like terms), (2) conducting agent(s), and (3) a binder.

The Si-based active material generally includes about 40-80% by weight silicon, about 60-20% by weight graphite, about 5-15% by weight titanium dioxide, and up to about 10% or 15% by weight polymer coating. The total of silicon, graphite, titanium dioxide and polymer coating are 100% by weight. The silicon, graphite, and titanium dioxide may have an average particle size of about 10 μm to about 100 μm.

Graphite is a commercially available lithium-ion battery anode material. Silicon-graphite composite anode material has been investigated and expected to replace Graphite as the anode material in Lithium-ion batteries. Si-Gr composite anode reported in prior art literature to date has generally been limited to a silicon content of less than 30%. According to the present invention, Si-Gr composite anodes having a Si content of 40-80% have been achieved.

The anode composite material may include Titanium dioxide which has good lithium-ion conductivity and an increasing electrical conductivity when lithiated TiO₂ (LixTiO₂, 0≤×≤1). The rigidity of TiO₂ compensates and diminishes the deformation of Si particles in the course of charging and discharging.

In some embodiments, the Si-based anode material comprises a polymer coating outside the Si-based composite particles, such as poly (vinyl alcohol) (PVA) or similar polymer. The polymer may act as a buffer layer to Si particles to accommodate the volume change of original Si particles, resulting from its resiliency. PVA coating wraps on the Si particle surfaces by covalently bonding. These formed covalent bonds enhance the mechanical strength between Si particles and the coating layer, leading to limited volume change during repeated lithiation and delithiation, thus enhancing stability and a longer cycling life of resultant lithium-ion batteries.

The Si-based active material may be processed into a Si anode, which includes (1) Si-based active material and may include (2) a conducting agent(s) and/or (3) a binder(s).

The conducting agent is an electronically conductive material that is preferably made of carbon. The electronically conducting agent may be, for example, carbon black or a carbon mix which comprises carbon black (0-100 wt %), few-layer graphene (FLG) (0-60 wt %), graphite (0-50 wt %), and poly(acrylic acid) (PAA, 0-5 wt %).

In some embodiments, the electrolyte-infiltrated Si-based composite anode includes a binder, such as if the active material weight percentage is high (for example, >50 wt %). Preferred binders may be selected from the group consisting of: poly(acrylic acid) (PAA), polyvinyl alcohol (PVA), and a combination thereof. Specifically, the combination of PAA and polyvinyl alcohol (PVA) (PAA-PVA) may be selected from a combination having a PAA: PAA-PVA content of about 30% to 90 wt % and a combination of partially neutralized PAA (pnPAA) and PVA (pnPAA-PVA) having a pnPAA: pnPAA-PVA content of about 50% to 90 wt %). The combination of PAA and PVA solution realize the strong adhesion properties of PAA and the mechanical robustness of PVA. The resultant PAA-PVA binder overcomes technical challenges faced by the polyvinylidene fluoride (PVDF) binder known in the art, such as brittleness, short service life, and poor interface adhesion. The PAA-PVA binder in a Si-based composite anode shows higher stiffness, adhesion strength, and electrochemical performance evidenced in the forms of longer and more stable cycling life.

Generally, the inventive Si-based anodes include about 60 to 96 wt % Si-based anode material, about 2 to 20 wt % conducting agent, and about 2 to 20 wt % binder.

A method of making a PAA solution may include adding PAA (weight average molecular weight [Mw]: about 450 k, about 10-15 wt %) into de-ionized water under magnetic stirring at about 200 rpm for about 1-2 hours. The PAA solution may be left to stand for about 12-24 hours to degas before using.

A method of making a PVA solution may include adding PVA (Mw: about 98 k, about 10-15 wt %) into de-ionized water under magnetic stirring at about 200 rpm for about 1-2 hours at about 60-80° C. The transparent PVA solution may be left to stand for 12-24 hours to degas before using.

A method of making a PAA-PVA combination binder solution includes preparing a PAA solution and a PVA solution. The PAA solution (about 10-15 wt %) and the PVA solution (about 10-15 wt %) may be mixed in a PAA: PVA mass ratio of about 0.25 to 4.00 under magnetic stirring at about 200 rpm for about 1-2 hours at about room temperature. The resultant PAA-PVA binder may be left stand for about 12-24 hours to degas before use in Si-based anode sheet production.

To further enhance the rheological properties and electrode porosity of PAA-PVA binder, Na ions (Na+) may be added to the PAA solution prior to mixing with PVA solution to partially neutralize PAA, with a neutralization degree of about 5-10%. PAA polymer chains tend to “self-bond” through hydrogen bonds. The introduction of NaOH to the PAA solution reduces self-bonding. Large amounts of H⁺are consumed with the addition of OH⁻. The electrostatic repulsion between neighboring dissociated carboxylate (—COOH) groups makes the polyacrylate chain stretch, leading to enhanced rheological properties of the PAA solution. Furthermore, an acidic condition created with the dissolution of electrolytic dissociation of carboxyl groups of PAA facilitates cross linking between PAA and PVA, leading to a stronger interconnection between different functional groups.

A method of preparing a NaOH solution (about 10-15 wt %) may include adding NaOH pellets to de-ionized water and magnetically stirring at about room temperature for about 5-10 min at about 200 rpm.

A method of preparing a partially neutralized PAA-PVA binder (pnPAA-PVA) includes preparing a PAA solution (about 10-15 wt %) and a PVA solution (about 10-15 wt %). NaOH solution may be added into the PAA solution in a ratio of NaOH:PAA=about 0.04:1-0.06:1 by weight) under magnetic stirring at about 200 rpm for about 1-2 hours. After degassing, the resulting pnPAA solution (about 10-15 wt %) may be mixed with the PVA solution (about 10-15 wt%) in a PAA: PVA mass ratio of about 0.25:1 to 4.00:1 under magnetic stirring at about 200 rpm for about 1-2 hours at about room temperature. The resultant PAA-PVA binder may be left standing for about 12-24 hours to degas before use in Si-based anode sheet production.

The cathodes may include any compatible material which functions as a positive pole in a lithium electrochemical cell. Preferred cathode active materials may be selected from the group consisting of: lithium iron phosphate (LFP)—LiFePO₄; LiNi_{0.8}Co_{0.1}Mn_{0.1}O₂ (Lithium Nickel Manganese Cobalt Oxide [NCM] 811); LiNi_{0.5}Co_{0.2}Mn_{0.3}O₂ (NCM 523); LiNi_{0.6}Co_{0.2}Mn_{0.2}O₂ (NCM 622); lithium nickel manganese oxide (LNMO)—LiNi_{0.5}Mn_{1.5}O₄; and mixtures thereof.

Lithium electrochemical cells and batteries employing Si-based anode have excellent rate performance as well as outstanding cycling stability (>500 cycles) over a wide range of temperature. Batteries with the novel Si-based anode meet severe specifications for wide temperature working range, quick charging requirements, and high energy density. The high specific capacity of the inventive Si-based anode active material (>2328 mAh/g @0.5 C charge-discharge rate) is more than 4 times that of the commercially available graphite anode (˜314 mAh/g @0.2 C rate). This anode is compatible with both commercially available liquid electrolytes and state-of-art solid-state electrolytes, which paves the road for high battery density (>300 Wh/kg).

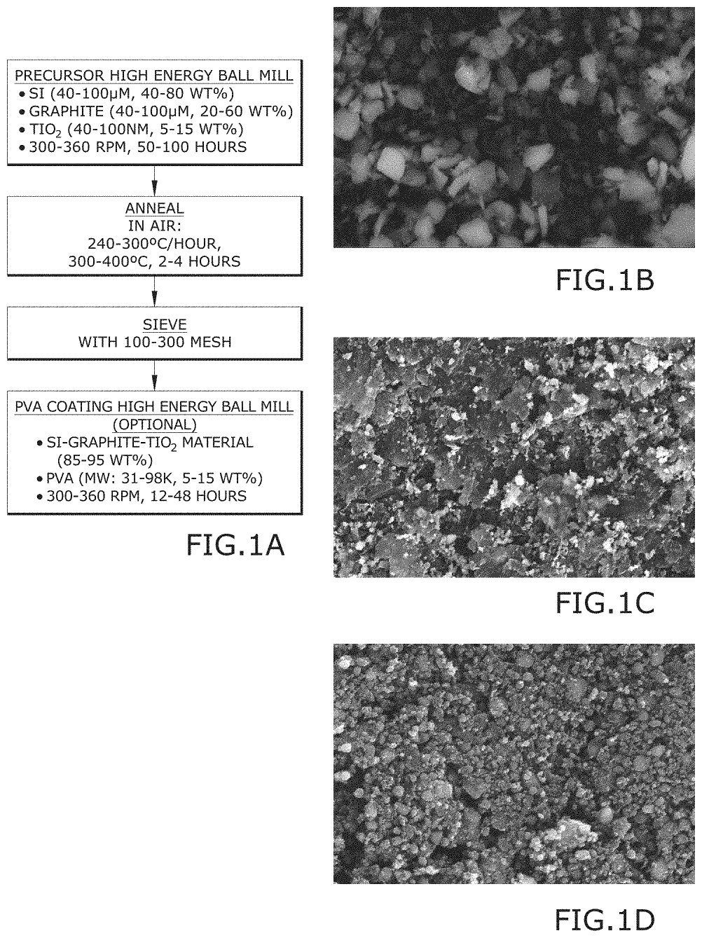

Referring to FIGS. 1A, 1B, 1C, 1D, 2, 3A, 3B, and 4 through 9, FIG. 1A illustrates a solid-state processing method according to an embodiment of the present invention to fabricate Si-based composite anode materials. As shown, 40-80% by weight silicon (10-100 μm), 20-60% by weight graphite (10-100 μm), and 5-15% by weight titanium oxide (40-100 nm) are added in a planetary ball milling machine and milled for 50-100 hours at a milling speed of 300-360 rpm. The ball milled precursor is moved to an air furnace and annealed at a temperature of 300-400° C. for 2-4 hours. The heating rate of the annealing process is 240-300° C./hour. To achieve a nano size powder, the annealed powder is sieved with a 100-300 mesh. The sieved Si-based composite active material is ready to use to prepare Si-based anodes for assembly into lithium-ion batteries. To further coat the Si-based active material with a polymer buffer layer, polyvinyl alcohol (PVA, Mw: 31-98 k, 5-15 wt %) is added to a planetary ball milling machine along with the sieved Si-graphite-Titanium oxide composite material in an Argon atmosphere or another inert atmosphere. Ball milling proceeds for from 12 hours to 48 hours. The PVA polymer covers the Si particle surfaces during the ball-milling process. PVA polymer chains hold Si particles to prevent huge volume expansion and shrinkage during the charge-discharge process when used in a lithium-ion battery. The solid-state processing procedure to manufacture Si-based composite material is straight forward, cost-effective, scalable, and suitable for large-scale production. No machines other well-known components of anode production lines are needed to manufacture the Si-based anode active material. The raw materials to prepare Si-based composite materials are economic while the resultant Si-based anode materials deliver much higher (e.g., more than 4 times larger) specific capacity (1200-3000 mAh/g) than prior art graphite anode materials (372 mAh/g), leading to a high volumetric and gravimetric energy density of the resultant Lithium-ion batteries.

FIG. 1B depicts a scanning electron microscope (SEM) of the pristine Si particles (10-100 μm) before processing. FIG. 1C is a SEM image of the Si-based composite anode active material before coating with polymer. The composite materials in this image have been subjected to high energy ball milling in an air atmosphere for 10-100 hours, annealing at 150-500° C. for 2-4 hours, and sieving with 100 mesh. The primary particle size has been reduced to 3-4 μm. FIG. 1D is a SEM image of the Si-based composite anode active material (Si-graphite-titanium oxide-PVA) that has been coated with PVA polymer by high energy ball milling in Ar atmosphere. Si-based composite particles are wrapped with resilient PVA coatings that covalently bond to Si particles. In the SEM image, it is shown that Si particles are surrounded by fine PVA particles.

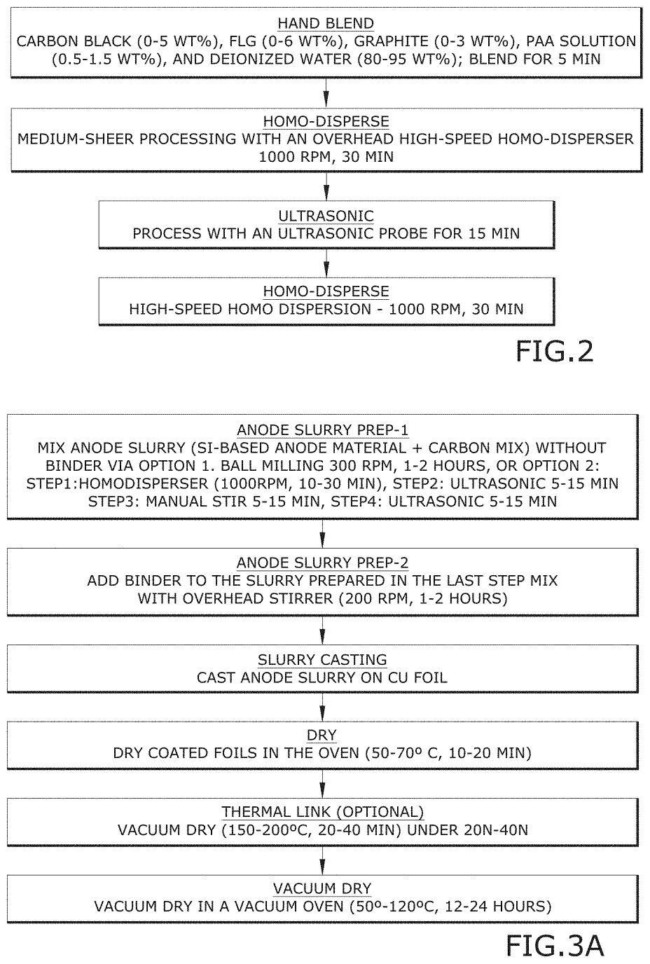

FIG. 2 shows a method of preparing a carbon mix for the Si-based anode. Carbon black, graphite, FLG, and a small amount of PAA solution was weighed and mixed with deionized water such that the carbon mix had a total solid percentage of ˜10-15 wt %. To mix conductive agents uniformly, the composition was mixed for 30 min, followed by ultrasonic mixing for another 15 min. Finally, the mix was homo dispersed at 1000 rpm for another 30 min until a uniform carbon mix was achieved.

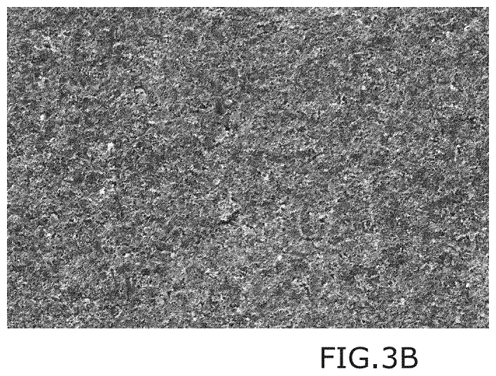

FIG. 3A depicts a method of preparing Si-based anode sheets. Anode slurry without binder was prepared from the Si-based anode material and the carbon mix and mixed by ball milling at 300 rpm for 1-2 hr(s) or by a combination of mixing methods. For example, the composition was mixed by a sequence of homo-dispersing at 1000 rpm for 10-30 min, and ultrasonic mixing for 5-15 min. After a uniform mixture of Si-anode material and carbon mix was achieved, a binder, PAA-PVA, for example, was added to the mixture with an overhead stirrer at 200 rpm for 1-2 hr(s) to form an anode slurry. The anode slurry was cast on Cu foil and oven dried at 50-70° C. for 10-20 min. In some embodiments, thermal link was applied on the oven-dried Si anode sheet and vacuum dried at 150-200° C. for 20-40 min at a predetermined pressure to facilitate the formation of cross-linking between polymer chains and the surface of Si particles. The Si anode sheet was then vacuum dried in a vacuum oven at 50-120° C. for 12-24 hrs. The resulting anode sheet was ready for assembly into a lithium-ion battery. FIG. 3B is a SEM image of a Si-based anode sheet made according to the method of FIG. 3A, comprising the Si-based active material, carbon black, and PAA-PVA binder. The materials are uniformly distributed in the vision field.

### EXAMPLE 1

In an example, a half coin cell containing a Si-based anode, a commercially available liquid electrolyte, and a lithium metal electrode was evaluated. The PVA-coated Si-based anode material comprised Si-based active material: carbon mix: pnPAA-PVA in a weight ratio of 6:2:2. The PVA-coated Si-based material was prepared by the solid-state method with 45% by weight Silicon (10-100 μm), 40% by weight graphite (10-100 μm), and 15% by weight titanium oxide (20-200 nm) mixed in a planetary ball milling machine and milled for 50 hours at a milling speed of 300 rpm. The ball milled precursor was moved to an air furnace and annealed at a temperature of 350° C. for 2 hours. The annealed powder was sieved with 100 mesh and then coated with a polymer buffer layer, polyvinyl alcohol (PVA, Mw: 31-98 k, 5 wt %). The carbon mix comprised 2.6 wt % carbon black, 5.2 wt % FLG, 2.6 wt % graphite, 0.5 wt % PAA solution. Then the Si-based active material was mixed with the carbon mix by homo-dispersing at 1000 rpm for 10-30 min, and ultrasonic mixing for 5-15 min. After the Si-anode material and carbon mix were uniformly mixed, the binder, pnPAA-PVA, was added. To prepare the partially neutralized PAA-PVA binder (pnPAA-PVA), PAA solution (13 wt %) and PVA solution (13 wt %) were prepared first. NaOH solution was then added into PAA solution at a weight ratio of NaOH:PAA of 0.05:1 under magnetic stirring at 200 rpm for 2 hours. After degassing, the pnPAA solution (13 wt %) is mixed with the PVA solution (13 wt %). The resultant PAA-PVA binder was left to stand for 12-24 hours to degas before applying into the Si anode slurry preparation. The final anode slurry was cast on Cu foil and oven dried at 70° C. for 20 min. The Si anode sheet was then vacuum dried in a vacuum oven at 120° C. for 24 hrs and assembled into coin cells with a liquid electrolyte (1 M LiPF₆ in ethylene carbonate/diethyl carbonate [EC/DEC] solution (1:1)) and a separator (Celgard® 3501).

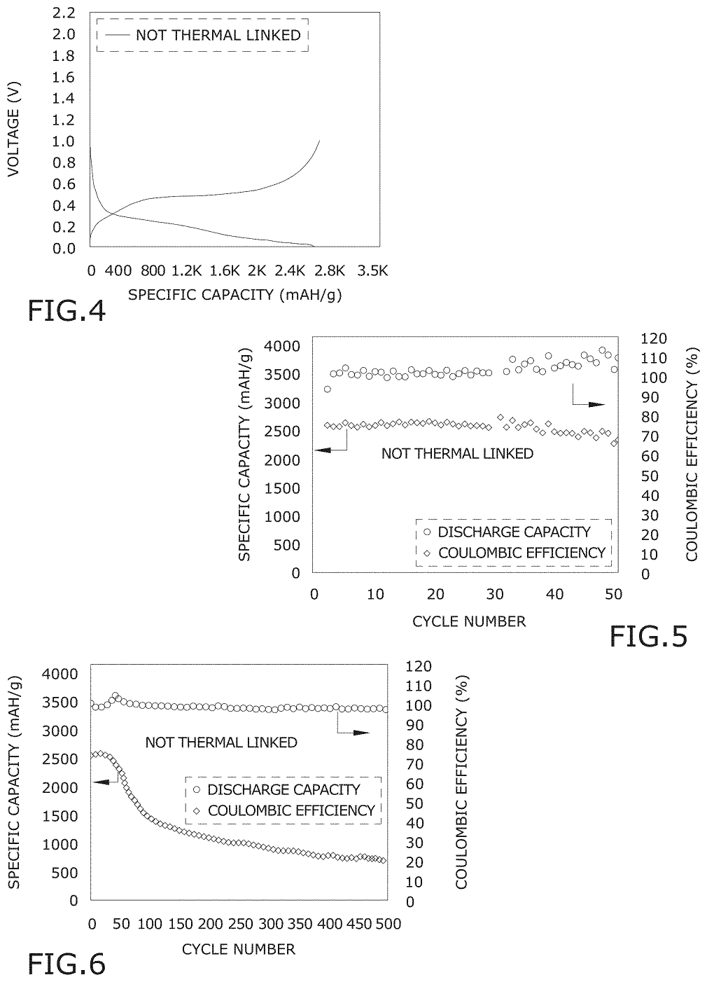

FIG. 4 is a charge-discharge profile of the half coin cell described in Example 1. The Si anode delivered a discharge specific capacity larger than 2500 mAh/g at 0.5 C rate. The high capacity of the Si-based anode according to the present invention enabled a reduction in thickness and weight of the anode, thus an improvement of the battery energy density. FIGS. 5 and 6 are cycling profiles of the half coin cell at 0.5 C rate. The discharge capacity was steady above 2500 mAh/g at 0.5 C rate for the first 50 cycles with a discharge capacity retention rate of 90% (2315 mAh/g) at the 50th cycle. Even at the 500th cycle, as seen in FIG. 6, the cell delivers a specific capacity of more than 750 mAh/g, which was more than 2 times the theoretical specific capacity of graphite. The co-binder PAA-PVA prevented the Si particles from deformation during the charge-discharge process, along with the polymer coating on the Si particles themselves.

### EXAMPLE 2

In another example, to further improve the Si-based anode performance, a thermal linked Si-based anode has been investigated, based on Example 1. The composition and formulation of the Si-based anode was the same as disclosed in Example 1 until the oven dry process. The final anode slurry was cast on Cu foil and oven dried at 70° C. for 20 min. Thermal link was applied on the oven-dried Si anode sheet and vacuum dried at 150° C. for 20 min. The Si anode sheet was then vacuum dried in a vacuum oven at 120° C. for 24 hrs. The anode sheet was then assembled into a lithium-ion battery with a liquid electrolyte (1 M LiPF6 solution in EC/DEC (1:1)) and a separator (Celgard® 3501).

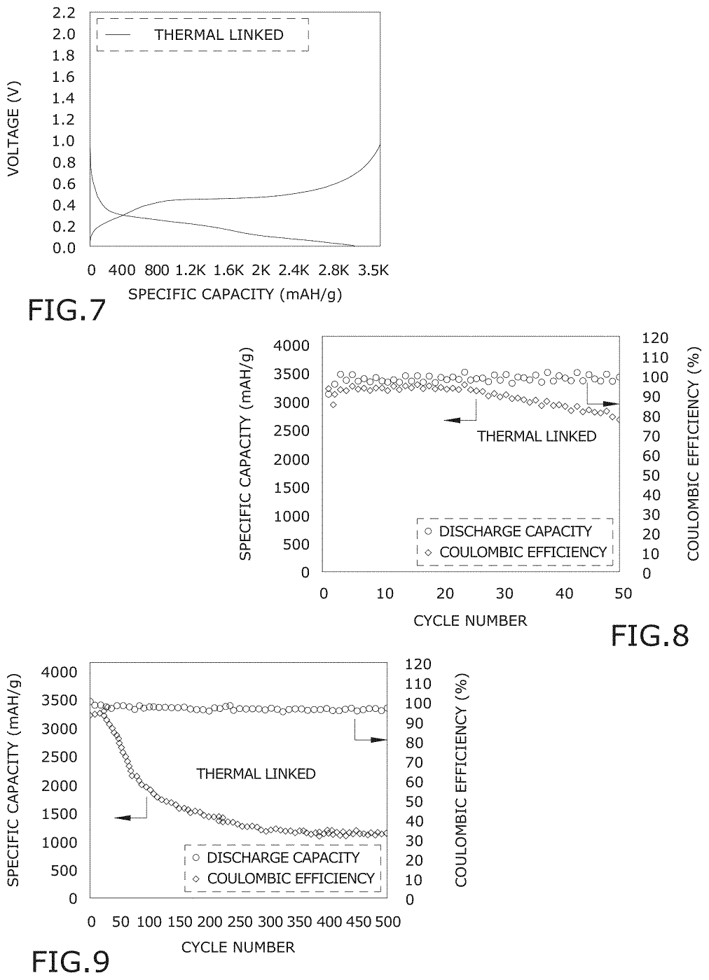

FIG. 7 is a charge-discharge profile of the half coin cell with the liquid electrolyte and thermal linked Si-anode described in Example 2. The Si anode delivered a discharge specific capacity of 3245 mAh/g at 0.05 C rate. FIGS. 8 and 9 are cycling profiles of the half coin cell at 0.5 C rate. The discharge capacity was steady above 2600 mAh/g at 0.5 C rate for the first 50 cycles with a discharge capacity retention rate of 83% (2695 mAh/g) at the 50th cycle. Even at the 500th cycle, as seen in FIG. 9, the cell delivered a specific capacity of more than 1000 mAh/g, which was more than 3 times the theoretical specific capacity of graphite. The thermal linked PAA-PVA further prevented the Si particles from deformation during the charge-discharge process and delivered much higher discharge capacities.

It should be understood, of course, that the foregoing relates to exemplary embodiments of the invention and that modifications may be made without departing from the spirit and scope of the invention as set forth in the following claims.

What is claimed is:

1. A silicon-based anode comprising:
(a) a silicon-based anode active material;
(b) conductive agents; and
(c) a binder.

2. The silicon-based anode of claim 1, wherein the conductive agents are selected from the group consisting of: carbon black, few-layer graphene, graphite, poly(acrylic acid), and combinations thereof.

3. The silicon-based anode of claim 1, wherein the binder is selected from the group consisting of: poly(acrylic acid), polyvinyl alcohol, partially-neutralized polyvinyl alcohol, and a combination thereof.

4. The silicon-based anode of claim 1, wherein the silicon-based anode active material comprises 40-80 wt % silicon, 20-60 wt % graphite, 5-15 wt % metallic or nonmetallic oxide, and 5-15 wt % polymer, such that a total of the silicon-based anode active material is 100 wt %.

5. The silicon-based anode of claim 4, wherein the metallic or nonmetallic oxide has a particle size ranging from 20-200 nm.

6. The silicon-based anode of claim 1, wherein the silicon-based anode active material comprises silicon particles, graphite, a metallic oxide, and a polymer.

7. The silicon-based anode of claim 6, wherein the silicon particles have a particle size ranging from 10-100 μm.

8. The silicon-based anode of claim 6, wherein the graphite has a particle size ranging from 10-100 μm.

9. The silicon-based anode of claim 6, wherein the polymer is polyvinyl alcohol with a molecular weight ranging from 31 k to 98 k.

10. The silicon-based anode of claim 6, wherein the metallic oxide is titanium oxide.

11. An electrochemical cell comprising:
(a) a silicon-based anode that comprises: (i) a silicon-based anode active material, (ii) a first conductive agent, and (iii) a first binder;
(b) a cathode that comprises: (i) a cathode active material, (ii) a second conductive agent and (iii) a second binder; and
(c) a separator interposed the between the silicon-based anode and the cathode.

12. The electrochemical cell of claim 11, wherein the silicon-based anode active material comprises polymer-coated silicon particles, graphite, and a metallic oxide.

13. The electrochemical cell of claim 11, wherein the cathode active material is selected from the group consisting of: lithium iron phosphate, lithium nickel manganese cobalt oxide, lithium nickel manganese oxide, and mixtures thereof.

14. A process for preparing an electrochemical cell comprising:
(a) providing a silicon-based anode that comprises: (i) a silicon-based anode active material, (ii) a first conductive agent, and (iii) a first binder;
(b) providing a cathode that comprises: (i) a cathode active material, (ii) a second conductive agent and (iii) a second binder; and
(c) forming, interposed the between the silicon-based anode and the cathode, a separator or a solid-state electrolyte.

15. The process of claim 14, wherein the first binder is prepared by:
(a) mixing a poly(acrylic acid) solution with a polyvinyl alcohol solution; and
(b) degassing the mixed poly(acrylic acid) and polyvinyl alcohol solutions.

16. The process of claim 15, wherein preparation of the first binder further comprises mixing sodium ions into the poly(acrylic acid) solution before mixing the poly(acrylic acid) solution with the polyvinyl alcohol solution.

17. The process of claim 14, wherein the silicon-based anode active material is prepared by:
(a) ball-milling silicon, graphite, and titanium dioxide to produce a precursor material;
(b) annealing the precursor material to make an annealed powder; and
(c) sieving the annealed powder to produce a sieved annealed powder.

18. The process of claim 17, wherein the silicon-based anode active material is further prepared by:
(a) ball-milling the annealed powder from sieving with polyvinyl alcohol under an inert atmosphere.

19. The process of claim 17, wherein the silicone-based anode is prepared by:
(a) mixing carbon black, additional graphite, few-layer graphene, poly(acrylic acid) solution, and deionized water to produce a uniformly mixed slurry of the first conductive agent;
(b) mixing the sieved annealed powder and the uniformly mixed slurry of the first conductive agent to form an intermediate slurry;
(c) mixing the intermediate slurry and the first binder to form an anode slurry;
(d) casting the anode slurry on a substrate; and
(e) drying the anode slurry to form an anode sheet.

20. The process of claim 19, further comprising applying thermal link to the anode sheet; and vacuum drying the anode sheet.
